(19) United States
(12) Patent Application Publication
(10) Pub. No.: US 2013/0091242 A1
(43) Pub. Date: Apr. 11, 2013

(54) ELECTRONIC DEVICE WITH FUNCTION OF QUICKLY OPENING WEB PAGES AND METHOD THEREOF

(71) Applicant: QIANG YOU, Shenzhen City (CN)

(72) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/286,160

(22) Filed: Oct. 31, 2011

(30) Foreign Application Priority Data
Oct. 10, 2011 (CN) 201110304827.8

(51) Int. Cl. G06F 15/16

(52) U.S. Cl. 709/217

(57) ABSTRACT

An electronic device includes a storage unit, an input unit, a display unit, and a processing unit. The storage unit stores network addresses and web data associated with the network addresses. The input unit receives a network address from a user. The display unit displays web pages based on the network addresses and the web data. The processing unit includes a receiving module, an identifying module, an acquiring module, and a display module. The receiving module receives the network address. The identifying module identifies whether the received network address is one of the network addresses. The acquiring module acquires the web data associated with the input network address from the storage unit when the input network address is one of the network address stored in the storage unit. The display module displays a web page based on the received network address and the acquired web page.

### BACKGROUND

1. Technical Field

The present disclosure relates to electronic devices and particularly, to an electronic device with a function of quickly opening web pages and a method thereof.

2. Description of Related Art

In general, network addresses of web pages that are frequently viewed by a user are saved as favorites. However, when the user wants to open one of the saved web pages and a net speed is slow, it will waste a lot of time for the user to wait until the web page is opened. Also, if a network connection is interrupted, the web page will not be displayed until the network connection is restored, it will also waste much time for the user.

Therefore, what is needed is an electronic device with a function of quickly opening a web page to overcome the described limitations.

### BRIEF DESCRIPTION OF THE DRAWINGS

FIG. 1 is a block diagram of the hardware infrastructure of an electronic device capable of quickly opening web pages, in accordance with an exemplary embodiment.

FIG. 2 is a flowchart of a method for quickly opening web pages implemented by the electronic device of FIG. 1, in accordance with an exemplary embodiment.

### DETAILED DESCRIPTION

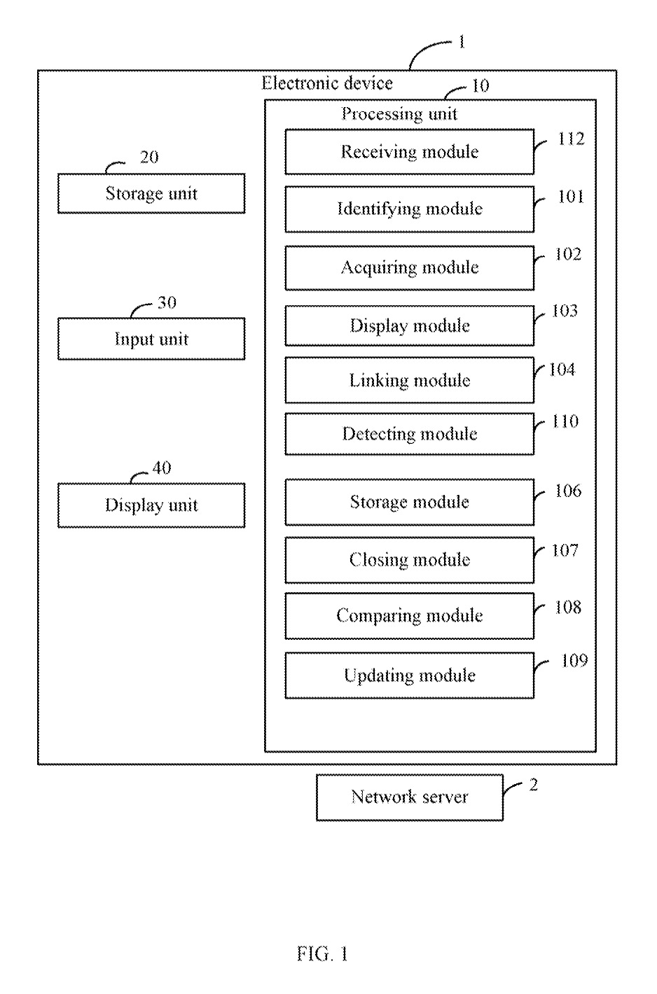

FIG. 1 shows an electronic device 1 with a function of quickly opening web pages. The electronic device 1 includes a processing unit 10, a storage unit 20, an input unit 30, and a display unit 40. The electronic device 1 is capable of communicating with a network server 2 to transmit data.

The storage unit 20 is configured to store a number of network addresses and web data associated with each of the network addresses. The input unit 30 is configured to receive the network address inputted by a user. The display unit 40 is configured to display a web page based on the network address and the web data associated with the network address.

The processing unit 10 includes a receiving module 112, an identifying module 101, an acquiring module 102, a display module 103, and a linking module 104.

The receiving module 112 is configured to receive the network address from the input unit 30.

The identifying module 101 is configured to identify whether the input network address is one of the network addresses stored in the storage unit 20.

The acquiring module 102 is configured to acquire the web data associated with the input network address from the storage unit 20 when the input network address is one of the network addresses stored in the storage unit 20.

The display module 103 is configured to display a web page on the display unit 40 based on the acquired web data.

The linking module 104 is configured to establish a link between the electronic device 1 and the network server 2 according to the input network address and acquire the web data associated with the input network address from the network server 2, when the input network address is not one of the network addresses stored in the storage unit 20.

The display module 103 is further configured to display a web page on the display unit 40 based on the acquired web data from the network server 2.

The processing unit 10 further includes a detecting module 110, a storage module 106, a closing module 107, a comparing module 108 and an updating module 109.

The detecting module 110 is configured to detect whether there is a first close instruction or a second close instruction input by the user. If there is a first close instruction, the closing module 107 closes the web page being displayed on the display unit 40 and the linking module 104 disconnects the link between the electronic device 1 and the network server 2.

If there is a second close instruction, the storage module 106 acquires the network address and the web data of the web page from the network server 2, and saves the acquired network address and the web data to the storage unit 20 according to the second close instruction. The closing module 107 then closes the web page being displayed on the display unit 40 and the linking module 104 maintains the link between the electronic device 1 and the network server 2. The linking module 104 acquires new web data associated with the network address of the web page being saved in real time.

The comparing module 108 is configured to compare the new web data with corresponding original web data associated with the network address to determine whether the new web data is consistent with the original web data.

The updating module 109 is configured to update the web data associated with the network address in the storage unit 20 by replacing the original web data with the new web data when the new web data is not consistent with the original web data.

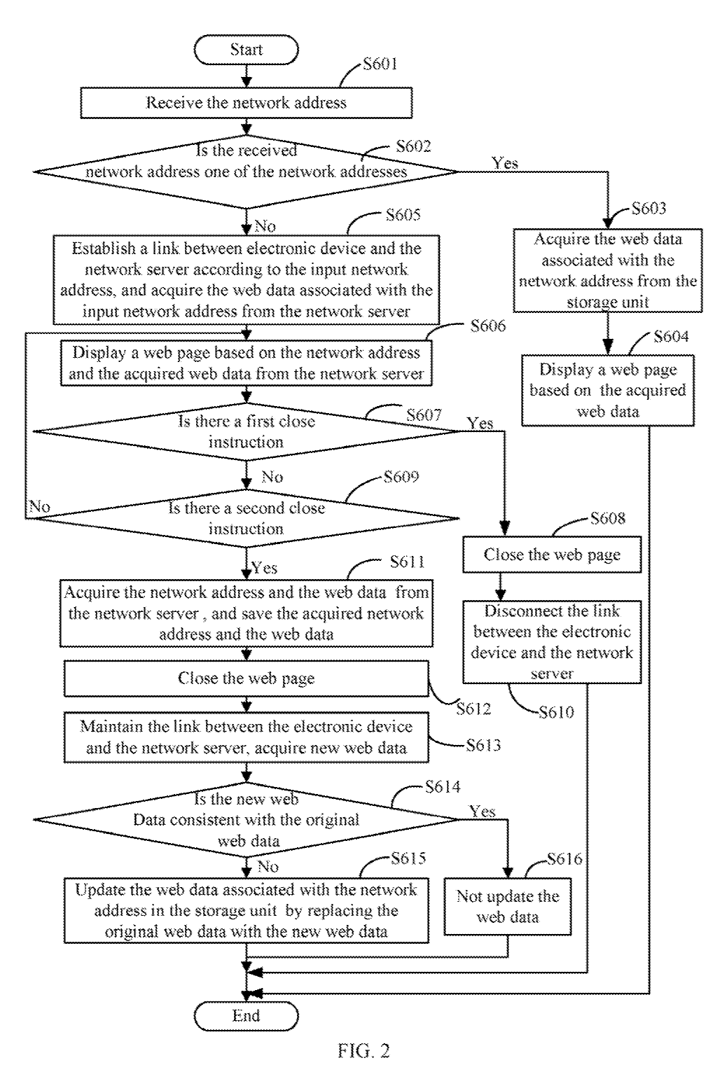

FIG. 2 is a flowchart of a method for quickly opening web pages implemented by the electronic device of FIG. 1.

In step S601, the receiving module 112 receives the network address from the input unit 30.

In step S602, the identifying module 101 identifies whether the received network address is one of the network addresses stored in the storage unit 20, if yes, the procedure goes to step S603, if no, the procedure goes to step S605.

In step S603, the acquiring module 102 acquires the web data associated with the input network address from the storage unit 20.

In step S604, the display module 103 displays a web page on the display unit 40 based on the acquired web data.

In step S605, the linking module 104 establishes a link between the electronic device 1 and the network server 2 according to the input network address, and acquires the web data associated with the input network address from the network server 2.

In step S606, the display module 103 displays a web page on the display unit 40 based on the acquired web data from the network server 2.

In step S607, the detecting module 110 detects whether there is a first close instruction input by the user, if yes, the procedure goes to step S608, if no, the procedure goes to step S609.

In step S608, the closing module 107 closes the web page according to the first close instruction.

In step S610, the linking module 104 disconnects the link between the electronic device 1 and the network server 2.

In step S609, the detecting module 110 detects whether there is a second close instruction input by the user, if yes, the procedure goes to step S611, if no, the procedure goes to step S606.

In step S611, the storage module 106 acquires the network address and the web data of the web page from the network server 2, and saves the acquired network address and the web data to the storage unit 20 according to the second close instruction.

In step S612, the closing module 107 closes the web page being displayed on the display unit 40.

In step S613, the linking module 104 maintains the link between the electronic device 1 and the network server 2, acquires new web data associated with the network address of the web page being saved in real time.

In step S614, the comparing module 108 compares the new web data with the corresponding original web data associated with the network address to determine whether the new web data is consistent with the original web data, if yes, the procedure goes to step S616, if no, the procedure goes to step S615.

In step S615, the updating module 109 updates the web data associated with the network address in the storage unit 20 by replacing the original web data with the new web data when the new web data is not consistent with the original web data.

In step S616, the updating module 19 does not update the web data associated with the network address.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device with a function of opening web pages, comprising:
a storage unit configured to store a plurality of network addresses and web data associated with each of the network addresses;
an input unit configured to receive a network address from a user;
a display unit configured to display a web page based on the network address and the web data associated with the network address; and
a processing unit comprising:
a receiving module configured to receive the network address from the input unit;
an identifying module configured to identify whether the received network address is one of the network addresses stored in the storage unit;
an acquiring module configured to acquire the web data associated with the input network address from the storage unit when the input network address is one of the network addresses stored in the storage unit; and
a display module configured to display a web page on the display unit based on the acquired web data associated with the network address.

2. The electronic device as described in claim 1, wherein the processing unit further comprises:
a linking module configured to establish a link between the electronic device and a network server according to the input network address, and acquire the web data associated with the input network address from the network server when the input network address is not one of the network addresses stored in the storage unit; and
the display module further configured to display a web page on the display unit based on the acquired web data from the network server.

3. The electronic device as described in claim 2, wherein the processing unit further comprises:
a detecting module configured to detect whether there is a first close instruction or a second close instruction input by the user;
a closing module configured to close the web page being displayed on the display unit according to the first close instruction; and
the linking module further configured to disconnect the link between the electronic device and the network server according to the first close instruction.

4. The electronic device as described in claim 3, wherein the processing unit further comprises:
a storage module configured to acquire the network address and the web data of the web page from the network server, and save the acquired network address and the web data to the storage unit according to the second close instruction;
the closing module further configured to close the web page being displayed on the display unit according to the second close instruction;
the linking module further configured to maintain the link between the electronic device and the network server, and acquire new web data associated with the network address of the web page being saved in real time according to the second close instruction;
a comparing module configured to compare the new web data with corresponding original web data associated with the network address to determine whether the new web data is consistent with the original web data; and
an updating module configured to update the web data associated with the network address in the storage unit by replacing the original web data with the new web data when the new web data is not consistent with the original web data.

5. A method for opening web pages implemented by an electronic device, wherein the electronic device comprises a storage unit, an input unit, and a display unit, the storage unit is configured to store a plurality of network addresses and web data associated with each of the network addresses, the input unit is configured to receive a network address from a user, and the display unit is configured to display a web page based on the network addresses and the web data associated with the network address, the method comprising:
receiving the network address from the input unit;
identifying whether the received network address is one of the network addresses stored in the storage unit;
acquiring the web data associated with the input network address from the storage unit when the input network address is one of the network addresses stored in the storage unit; and
displaying a web page on the display unit based on the acquired web data associated with the network address.

6. The method as described in claim 5, further comprising:
establishing a link between the electronic device and a network server according to the input network address, and acquiring the web data associated with the input network address from the network server when the input network address is not one of the network addresses stored in the storage unit; and
displaying a web page on the display unit based on the acquired web data from the network server.

7. The method as described in claim 6, further comprising:
detecting whether there is a first close instruction or a second close instruction input by the user;
closing the web page being displayed on the display unit according to the first close instruction; and
disconnecting the link between the electronic device and the network server according to the first close instruction.

8. The method as described in claim 7, further comprising:
acquiring the network address and the web data of the web page from the network server, and saving the acquired network address and the web data to the storage unit according to the second close instruction;
closing the web page being displayed on the display unit according to the second close instruction;
maintaining the link between the electronic device and the network server, and acquiring new web data associated with the network address of the web page being saved in real time according to the second close instruction;
comparing the new web data with corresponding original web data associated with the network address to determine whether the new web data is consistent with the original web data; and
updating the web data associated with the network address in the storage unit by replacing the original web data with the new web data when the new web data is not consistent with the original web data.
